(19) United States
(12) Patent Application Publication
(10) Pub. No.: US 2023/0397626 A1
(43) Pub. Date: Dec. 14, 2023

(54) NON-ANIMAL PROTEIN BASED CHEESE AND PROCESSES FOR PRODUCING

(71) Applicant: Archer Daniels Midland Company, Decatur, IL (US)

(72) Inventors: Kathryn Kolpin-Gustafson, Newport, KY (US); Sophie Held, Madison, WI (US)

(21) Appl. No.: 18/251,054

(22) PCT Filed: Oct. 28, 2021
(86) PCT No.: PCT/US2021/057090

§ 371 Date: Apr. 28, 2023

Related U.S. Application Data
(60) Provisional application No. 63/106,650, filed on Oct. 28, 2020.

(51) Int. Cl. A23C 20/02; A23J 3/16; A23J 3/14

(52) U.S. Cl. CPC A23C 20/025; A23J 3/16; A23J 3/14

(57) ABSTRACT

Non-animal protein-based cheeses and processes for producing are disclosed. A process of producing a cheese base includes mixing a hydrated non-animal protein with a fat, thus producing a mixture, and mixing an acid with the mixture to form a curd. The curd may be used to form soft or hard cheeses. The curd may be mixed with different ingredients, thus producing a mixture. The mixture may be mixed, thus producing a cheese composition and placed into a mold.

### FIELD OF THE INVENTION

The present invention relates generally to non-animal protein-based cheese products. More particularly, the present invention relates to processes for producing animal protein free cheese, vegan cheese, and products produced therefrom.

### BACKGROUND OF THE INVENTION

Most vegan cheeses are made with a combination of starch, water, and saturated fat. Such vegan cheeses are typically available in block or shred form and do not contain any appreciable amount of protein. Further, most of the traditional vegan cheeses lack the flavor and texture of dairy cheeses due to, in part, because the proteins used in such vegan cheeses do not mimic the casein found in dairy cheese.

What is needed is a vegan or non-animal protein-based cheese that is similar in texture and flavor to dairy cheese.

### SUMMARY OF THE INVENTION

In each of various embodiments, the present invention fulfills these needs and discloses non-animal protein-based cheeses and processes for producing.

In one embodiment, a process of producing a cheese product includes mixing a hydrated non-animal protein with a fat, thus producing a mixture, and mixing an acid with the mixture such that a curd forms.

The curd may be used as a cheese base to produce hard or soft cheeses.

In a further embodiment, a process of producing a soft cheese includes mixing a curd comprising a non-animal protein and a fat with a compound selected from the group consisting of a flavoring, a salt, an acid, a colorant, a flavor masker, an herb, and combinations of any thereof.

In an additional embodiment, a process of producing a hard cheese comprises mixing a curd comprising a non-animal protein and a fat with a compound selected from the group consisting of a starch, a flavoring, a flavor masker, an additional fat, a colorant, an emulsifying salt, a salt, an acid, water, an additional protein, and combinations of any thereof, thus producing a hard cheese base. The hard cheese base is heated, agitated, formed, and cooled to product the hard cheese.

In yet an additional embodiment, a process for producing a cheese base includes mixing a non-animal protein with water, thus producing a hydrated non-animal protein, mixing a fat with the hydrated non-animal protein, homogenizing the fat and the hydrated non-animal protein, thus producing a mixture, and adjusting a pH of the mixture to a pH at or below an isoelectric point of the non-animal protein to form a curd.

In yet another embodiment, a cheese base comprises 5-25% of a non-animal protein, 5-25% fat, and 50-90% water, wherein the pH of the composition is at or below an isoelectric point of the non-animal-based protein.

In another embodiment, a soft cheese includes 50-72% by weight water, 10-20% by weight fat, and 5-20% by weight of a non-animal protein.

In an additional embodiment, a hard cheese comprises 30-70% by weight water, 15-30% by weight fat, 10-20% by weight carbohydrate, and 5-20% by weight of a non-animal protein.

### DETAILED DESCRIPTION OF THE INVENTION

In each of its various embodiments of the present invention, a non-animal protein-based cheese base and cheeses produced with the cheese base are disclosed. The non-animal protein-based cheese may be vegan. The non-animal protein-based cheese is produced with novel processes to produce a soft or hard cheese-like texture, wherein the non-animal protein-based cheese may have a protein content that surpasses conventional non-animal protein based or vegan cheeses. In a further embodiment, the non-animal protein-based cheese of the present invention may have a protein content similar to analogous dairy cheeses. The non-animal protein-based cheeses disclosed herein may have a clean label and include ingredients including, but not limited to, protein maskers, flavor maskers, cheese flavors, vegan cheese flavors, and/or natural flavors such that the non-animal protein-based cheese has a flavor similar to that of dairy cheese.

The cheese product or cheese base may be produced by mixing a hydrated non-animal protein with a fat, thus producing a mixture, and mixing an acid with the mixture, such that a curd forms. The non-animal protein may be mixed with water to produce the hydrated non-animal protein. The curd may also be separated from any liquid in the mixture. The separating may be done by straining and/or pressing the curd with a filter or cheesecloth. During the process, the hydrated non-animal protein and the fat may also be heated and/or blended, thus homogenizing the hydrated non-animal protein and fat. A flavor may also be mixed with the curd to achieve a desired flavor profile.

The cheese product or cheese base may also be produced by mixing a non-animal protein with water, thus producing a hydrated non-animal protein, mixing a fat with the hydrated non-animal protein, homogenizing the fat and the hydrated non-animal protein, thus producing a mixture, and adjusting a pH of the mixture to a pH at or below an isoelectric point of the non-animal protein, such that a curd forms. The non-animal protein may be mixed with water to produce the hydrated non-animal protein. The curd may be separated from any liquid in the mixture by straining and/or pressing the curd with a filter of a cheesecloth. The hydrated non-animal protein and the fat may also be heated and/or blended to homogenize the hydrated non-animal protein and the fat. A flavor may also be mixed with the curd to a produce a desired flavor.

The curd may be used as is as a cheese base to produce a cheese, or the curd may be further strained and/or pressed to remove liquid and used as a cheese base to make hard and/or soft cheeses as described herein.

A soft cheese may be produced by mixing a curd comprising a non-animal protein and a fat with a compound selected from the group consisting of a flavoring, a salt, an acid, a colorant, a flavor masker, an herb, and combinations of any thereof, thus producing the soft cheese. The curd may be produced as described herein. The mixing may be performed cold or below ambient temperature. The soft cheese may include 50-100%, 60-95%, at least 90%, at least 95%, at least 99%, or 100% of the curd.

The curd used to produce the soft cheese may be produced by hydrating the non-animal protein, mixing a hydrated non-animal protein with the fat, thus producing a mixture, heating the hydrated non-animal protein and the fat, and mixing an acid with the mixture, such that the curd forms.

A hard cheese may be produced by mixing a curd comprising a non-animal protein and a fat with a compound selected from the group consisting of a starch, a flavoring, a flavor masker, an additional fat, a colorant, an emulsifying salt, a salt, an acid, water, an additional protein, and combinations of any thereof, thus producing a hard cheese base, heating the hard cheese base, agitating the hard cheese base, forming the hard cheese base, and cooling the hard cheese base. The curd may be produced as described herein. Heating of the hard cheese base may occur at a temperature of at least 145° F. and agitating the hard cheese base may occur at a temperature of at least 170° F. The hard cheese may include 50-90%, 60-85%, or 50-75% of the curd.

The curd used to produce the hard cheese may be made by a process including hydrating the non-animal protein, mixing a hydrated non-animal protein with the fat, thus producing a mixture, heating the hydrated non-animal protein and the fat, and mixing an acid with the mixture, such that the curd forms.

In one embodiment, the non-animal protein based soft cheeses of the present invention may be similar to chevre, cream cheese, ricotta, cold-pack cheese, and other soft cheeses. Such soft non-animal protein-based cheese may be configured to be spreadable and creamy.

In another embodiment, the non-animal protein based hard cheeses of the present invention may be similar to cheddar, provolone, colby, processed cheese, parmesan, or other block cheeses that can be sliced and/or shredded. In one embodiment, the non-animal protein based hard cheeses of the present invention are also able to melt and may have a restricted melt property. Such non-animal protein based hard cheeses may have utility in frozen and reheated products. The melted non-animal protein based hard cheese may also produce a coating and have a rich creamy mouthfeel, and optionally a soft peak pull similar to processed cheese.

In an embodiment, the cheeses disclosed herein are vegan, but could optionally include non-vegan ingredients and find utility in the flexitarian market.

In a further embodiment, the soft vegan-cheeses of the present invention may have various flavors added to them to achieve a desired flavor profile.

Non-animal proteins that may be used in the processes and compositions of the present invention include, but are not limited to, plant-based protein, a vegetable protein, a fungal protein, an insect protein, a tissue cultured protein, a fermented protein, a microorganism-based protein, a bacterial protein, and combinations of any thereof.

Vegetable proteins that may be used in the processes and compositions of the present invention include, but are not limited to, soy protein concentrate, soy protein isolate, pea protein concentrate, pea protein isolate, a legume protein a potato protein, a fava bean protein, a chickpea protein, a peanut protein, a canola protein, a legume protein isolate, a pulse protein concentrate, a pulse protein isolate, or other plant-based protein isolates or concentrates.

Acids that may be used in the processes and compositions of the present invention include, but are not limited to, lactic acid, propionic acid, phosphoric acid, acetic acid, other food grade acid that will function to drop the pH to the isoelectric point of the vegetable protein, salts of any thereof, and combinations of any thereof. In another embodiment, the acid may be any acid that imparts the flavor of a traditional cheese to the vegan cheese.

Fats that may be used in the processes and compositions of the present invention include, but are not limited to, vegetable oil, coconut oil, palm oil, cottonseed oil, cocoa butter, canola oil, soy oil, corn oil, hydrogenated vegetable oil, esterified vegetable oil, a saturated fat that melts below 170° F., a combination of a saturated and unsaturated fats that melts below 170° F., and combinations of any thereof.

In an embodiment, a cheese base comprises 5-25% of a non-animal protein, 5-25% fat, and 50-90% water. The cheese base has a pH that is at or below an isoelectric point of the non-animal-based protein. The composition may function as a cheese base.

In one embodiment, the soft plant-based cheeses described herein may have a content of about 50-72% water, 10-20% fat, and 5-20% of a non-animal protein. On a dry weight basis, the content may be about 25-70% fat and about 25-50% non-animal protein. In another embodiment, the soft plant-based cheese of the present invention may have 3-5 grams of protein per one ounce.

In a further embodiment, the hard plant-based cheeses described herein may have a nutritional content of about 10-20% carbohydrate, 15-30% fat, 5-20% non-animal protein, and water. In another embodiment, the hard plant-based cheese of the present invention may have 3-5 grams of protein per one ounce.

In an additional embodiment, a hard plant-based cheese may have a nutritional content in a 30-gram serving of: about 90 calories; about 8 grams of total fat; about 6 grams of saturated fat; about 450 mg of sodium; about 4 grams of carbohydrates; about 0 grams of sugar; about 1 gram of dietary fiber; about 2 grams of protein; and about 20 mg of calcium.

The nutritional content of the soft and hard plant-based cheese of the present invention may vary depending on a desired functionality of the cheese such as desired softness, hardness, being more crumbly, more spreadable, being more firm, having more or less stretch, being meltable, or other desired characteristics.

### Example 1

A process to produce a soft vegan cheese used water, a plant-based protein, a fat, an acid, a salt, and a flavoring.

50 grams of a soy protein concentrate (ARCON S brand soy protein concentrate, available from Archer-Daniels-Midland Company, Decatur, IL) was added to 900 grams of water and allowed to hydrate for at least one hour. The hydrated soy protein concentrate was placed in a heat-safe vessel with 50 grams of coconut oil and heated to 170° F. with constant agitation. The temperature of heating could be between 170-200° F. Once the heated products reached 170° F., a high-shear mixer was used to blend the heated mixture to ensure a homogenous solution.

4 grams of 60% lactic acid powder was diluted in water (0.08 grams of lactic acid per gram of soy protein concentrate) and gently stirred into the heated, homogenized product. The acidified product was allowed to sit for 20-30 minutes resulting in curd. The curd was strained with a cheese cloth and pressed to achieve a desired moisture level which in this Example was 66% moisture and 34% solids. The curd can be used as a cheese base. Flavors and/or salt can be added to the soft, acid-curd. In this Example, sodium chloride and vegan chevre flavor were added to product a chevre type vegan cheese. In other embodiment, a bitterness masker and/or flavor masker may also be used. The vegan cheese may be formed into any desired shape to produce the desired cheese.

### Example 2

A process to produce a block vegan cheese used water, a plant-based protein, a fat, an acid, a salt, and a flavoring.

50 grams of a soy protein concentrate (ARCON S brand soy protein concentrate, available from Archer-Daniels-Midland Company, Decatur, IL) was added to 900 grams of water and allowed to hydrate for at least one hour. The hydrated soy protein concentrate was placed in a pan with 50 grams of coconut oil and heated to 170° F. with constant stirring. Once the heated products reached 170° F., a high-shear mixer was used to homogenize the heated products.

4 grams of 60% lactic acid powder was diluted in water (0.08 grams of lactic acid per gram of soy protein concentrate) and gently stirred into the heated, homogenized product. The acidified product was allowed to sit for 20-30 minutes resulting in curd. The curd was strained with a cheese cloth and pressed to achieve a desired moisture level which in this Example was 66% moisture and 34% solids. The curd can be used as a cheese base to produce a cheese.

200 grams of the curd, 20 grams of a modified corn starch (PRECISA 604 modified corn starch available from Ingredion Incorp. of Westchester, IL), 15 grams of potato starch (PENPURE 80 brand potato starch available from Ingredion Incorp. of Westchester, IL), 5 grams of salt, and 2.5 grams of disodium phosphate were added to a scraped surface heating vessel and set to mix. 20 grams of water was added and mixed for 10-15 seconds to incorporate into the mixture. 40 grams of melted coconut oil was added along with any desired flavors and/or colors.

The vegan cheese mixture was mixed and heated until the vegan cheese mixture reached (175° C.). Upon reaching this temperature, the vegan cheese mixture was mixed for 3 minutes. The cooked vegan cheese mixture was placed into a lined mold, allowed to cool, and placed in a refrigerator for at least 24 hours to set up, resulting in a block of vegan cheese.

### Example 3

A block, cheddar cheese was made using a cheese base or curd as described herein, such as the cheese base produced in Example 2.

The block, cheddar cheese was made substantially as the hard cheese described in Example 2 with the following formulation: 65.92% of the cheese base; 9.89% water; 0.99% soy protein isolate; 9.89% coconut fat; 7.58% starch; 2.31% tapioca starch; 1.5% salt; 0.82% disodium phosphate (an emulsifying salt); 0.35% autolysed yeast; 0.5% cheddar flavor; 0.2% mouthfeel flavor; and 0.08% paprika oleoresin.

### Example 4

50 grams of a pea protein (PROFAM brand pea protein, available from Archer-Daniels-Midland Company, Decatur, IL) was added to 900 grams of water and allowed to hydrate. The hydrated pea protein was mixed with 50 grams of coconut oil and heated to 170° F. with constant agitation. Once the heated products reached 170° F., a high-shear mixer was used to blend the heated mixture to ensure a homogenous solution.

60% lactic acid powder was diluted in water and gently stirred into the heated, homogenized product until the pH of the product reached the isoelectric point of the pea protein, about a pH of 4.75. The acidified product was allowed to sit resulting in curd. The curd was strained with a cheese cloth and pressed to achieve a desired moisture level. The curd can be used as a cheese base to produce a soft or hard cheese.

This disclosure has been described with reference to certain exemplary embodiments, compositions, and uses thereof. However, it will be recognized by those of ordinary skill in the art that various substitutions, modifications, or combinations of any of the exemplary embodiments may be made without departing from the spirit and scope of the disclosure. Thus, the disclosure is not limited by the description of the exemplary embodiments, but rather by the appended claims as originally filed.

1. A process of producing a cheese product, the process comprising:
mixing a hydrated non-animal protein with a fat, thus producing a mixture; and
mixing an acid with the mixture, such that a curd forms.

2. The process of claim 1, further comprising separating the curd from any liquid in the mixture.

3. The process of claim 2, wherein the separating comprises straining and/or pressing the curd with a filter or cheesecloth.

4. The process of claim 1, wherein the non-animal protein is a plant-based protein, a vegetable protein, a fungal protein, an insect protein, a tissue cultured protein, a fermented protein, a microorganism-based protein, a bacterial protein, and combinations of any thereof.

5. The process of claim 4, wherein the plant-based protein is selected from the group consisting of soy protein, pea protein, canola protein, peanut protein, legume protein, potato protein, fava bean protein, chickpea protein, legume protein, pulse protein, other plant-based protein, concentrates of any thereof, isolates of any thereof, and combinations of any thereof.

6. The process of claim 1, further comprising heating the hydrated non-animal protein and the fat.

7. The process of claim 1, further comprising blending the heated, hydrated non-animal protein and the fat, thus producing a homogenized solution.

8-10. (canceled)

11. The process of claim 1, further comprising mixing a non-animal protein with water, thus producing the hydrated non-animal protein.

12. The process of claim 1, further comprising:
mixing a curd comprising a non-animal protein and a fat with a compound selected from the group consisting of a flavoring, a salt, an acid, a colorant, a flavor masker, an herb, and combinations of any thereof, thus producing the soft cheese.

13. The process of claim 12, wherein the mixing is performed cold.

14-16. (canceled)

17. The process of claim 1, wherein the curd is produced by a process comprising:
hydrating the non-animal protein;
mixing a hydrated non-animal protein with the fat, thus producing a mixture;
heating the hydrated non-animal protein and the fat; and
mixing an acid with the mixture, such that the curd forms.

18. The process of claim 1, further comprising:
mixing the curd with a compound selected from the group consisting of a starch, a flavoring, a flavor masker, an additional fat, a colorant, an emulsifying salt, a salt, an acid, water, an additional protein, and combinations of any thereof, thus producing a hard cheese base;
heating the hard cheese base;
agitating the hard cheese base;
forming the hard cheese base; and
cooling the hard cheese base.

19. The process of claim 18, wherein heating the hard cheese base comprises heating to at least 145° F.

20. The process of claim 18, wherein agitating the hard cheese base occurs at a temperature of at least 170° F.

21-25. (canceled)

26. A process for producing a cheese base, comprising:
mixing a non-animal protein with water, thus producing a hydrated non-animal protein;
mixing a fat with the hydrated non-animal protein;
homogenizing the fat and the hydrated non-animal protein, thus producing a mixture; and
adjusting a pH of the mixture to a pH at or below an isoelectric point of the non-animal protein, such that a curd forms.

27. The process of claim 25, further comprising separating the curd from any liquid in the mixture.

28-30. (canceled)

31. The process of claim 25, further comprising heating the hydrated non-animal protein and the fat.

32. The process of claim 25, further comprising blending the heated, hydrated non-animal protein and the fat, thus producing a homogenized solution.

32-33. (canceled)

34. The process of claim 25, further comprising mixing a flavor with the curd to produce a desired flavor profile.

35. The process of claim 25, further comprising mixing a non-animal protein with water, thus producing the hydrated non-animal protein.

36-55. (canceled)
